(19) United States
(12) Patent Application Publication
(10) Pub. No.: US 2026/0091918 A1
(43) Pub. Date: Apr. 2, 2026

(54) PORTABLE BLENDER WITH DRINK-THROUGH LID CLOSURE

(71) Applicant: Capbran Holdings, LLC, Los Angeles, CA (US)

(72) Inventor: Robert Finnance, Hartford, CT (US)

(73) Assignee: Capbran Holdings, LLC, Los Angeles, CA (US)

(21) Appl. No.: 18/900,297

(22) Filed: Sep. 27, 2024

Related U.S. Application Data
(63) Continuation-in-part of application No. 29/946,728, filed on Jun. 11, 2024.

(51) Int. Cl. B65D 51/16; A47J 43/046; B01F 27/808; B01F 33/501; B65D 47/08; B65D 47/32; B65D 51/32

(52) U.S. Cl. CPC B65D 51/1688; A47J 43/046; B01F 27/808; B01F 33/5011; B65D 47/0857; B65D 47/32; B65D 51/32; B65D 2205/02; B65D 2217/00

(57) ABSTRACT

A portable blender includes a container with a chamber and an opening to the chamber. A lid/base is arranged to be coupled to the container and seal the chamber. The has a power source, a motor, a control, and a blade assembly, with the blade assembly oriented toward the chamber. The lid/base also has a pour spout and a vent which both open into the sealed chamber. A closure mechanism is provided for sealing the pour spout and vent, with a stopper configured to cover the pour spout and a vent cover configured to cover the vent. The closure mechanism is arranged such that stopper movement governs vent cover movement, with stopper movement away from the pour spout causing vent cover movement away from the vent, and stopper movement to cover the pour spout moves the vent cover to cover the vent.

### FIELD OF THE INVENTION

The present invention relates to blenders and portable blenders for personal use. More specifically, the present invention relates to a portable blender for personal use having a drink-through lid and a re-sealing drink-through lid closure.

### BACKGROUND

Blenders are well known in the art, as are portable battery powered blenders designed for personal use. Portable battery powered blenders typically comprise a vessel portion for containing a product to be blended and for housing the blended product, and a base which houses an on-board battery, motor, blending blade, and controls for operating the blender. Other features may include a lid opposite the base which may serve as a handle for carrying the blender, and which may be removable for consuming blended components directly from the vessel with the base attached.

One drawback with portable blenders as known in the art is the inability to quickly and conveniently consume a beverage once blending is complete. If a portable blender has only a vessel and a base, the user must unscrew the base to drink from the vessel. Post blending, the base, which retains a residue of blended material, risks dripping and is prone to create a mess when removed. Alternatively, in the instance of a portable blender with a lid opposite the base, the lid must be removed and held separately while fluids are consumed from the vessel. These designs have the added problem of needing safety features to prevent the motor in the base from activating when the lid is removed, which presents a difficult engineering problem that results in added development and manufacturing expense.

For these reasons it is an object of the present invention to provide a personal portable blender which provides access to a blended material without having to remove a lid or base from the blender vessel. A further object is to provide a personal portable blender providing an easily openable and closeable access to the inside of the blender vessel. Yet another object of the invention is to provide a personal portable blender having a stable base for blending that also serves as a serving lid for consuming a beverage from the blender. These and other objects are more fully described in the following specification and illustrations.

### SUMMARY

A portable blender apparatus includes a container which has a chamber with an opening to the chamber. A lid/base structure, functioning alternatively as a drink through lid for drinking from the blender, and a motor base for blending material in the container, is configured to be coupled to the container and thereby seal the chamber. Among other features, the lid/base includes a power source, a motor, a control system for operating the blender, and a blade assembly. The blade assembly is oriented toward the chamber, and may extend into the chamber.

The lid/base structure includes a pour spout and a vent which are both open to the sealed chamber, allowing air in the container to equalize and thus enabling a user to smoothly decant material from the container. A closure mechanism is provided, including a stopper configured to cover the pour spout, and a vent cover configured to cover the vent. The closure mechanism is configured such that movement of the stopper governs movement of the vent cover. Namely, moving the stopper away from the pour spout causes the vent cover to move away from the vent and moving the stopper to cover the pour spout moves the vent cover to cover the vent.

In various embodiments, the stopper may be connected to the lid/base by a hinge, and the vent cover may be connected to the lid/base by a hinge. The stopper may have two arms, extending away from the pour spout opening, and wherein the vent cover may be disposed between the two arms. The vent cover preferably has at least one side tab configured to be engaged by the stopper, with the stopper configured to urge the side tab toward the lid/base when the stopper is moved toward the pour spout.

The vent cover may include at least one side notch configured to be engaged by the stopper. The stopper also preferably includes at least one off-set peg which is configured to engage the side notch and urge the vent cover away from the vent when the stopper is moved away from the pour spout. Preferably, the stopper is configured to re-capture the vent cover when the vent is uncovered, and move the vent cover toward the vent as the stopper moves toward the pour spout. Thus, moving the stopper out of the pour spout and back in, causes the vent cover to uncover the vent and cover it back up.

In various other embodiments, the lid/base includes slot for receiving and retaining the stopper when the stopper is moved away from the pour spout. The lid/base may also have a flat profile opposite the container, which allows the lid/base to rest on a surface with the container above the lid/base in the manner of a conventional bullet-type blender. The chamber may have at least one rib configured to introduce turbulence during blending, effectively stirring the contents of the blender.

In one preferred embodiment, the lid/base has a fence surrounding the blade assembly, with the fence extending farther away from the lid/base than the blade assembly for protection. In other embodiments, the fence may incorporate at least one notch, providing access to the blade assembly. In another embodiment, the blade assembly has a single upturned blade, and may have a number of downwardly sloped blades.

The apparatus may also be characterized as a portable blender having a container with a chamber and an opening, a lid/base coupled to the container to seal the chamber, and a power source, motor, control mechanisms, and a blade assembly oriented toward the chamber. The lid/base including a pour spout and a which are open to the sealed chamber, with a stopper and vent cover to close them, with movement of the stopper governing movement of the vent cover. In this instance, a first movement of the stopper away from the pour spout causes the vent cover to move away from the vent, a second movement of the stopper to cover the pour spout moves the vent cover to cover the vent, and a third movement of the stopper away from the pour spout disengages the stopper from the vent cover.

The vent cover may have at least one side tab configured to be engaged by the stopper, wherein urging the at least one side tab toward the lid/base when the stopper moves toward the pour spout. The vent cover may also have at least one side notch configured to be engaged by the stopper and the stopper comprises at least one off-set peg configured to engage the side notch, wherein the off-set peg urges the vent cover away from the vent when the stopper is moved away from the pour spout. The stopper may be configured to re-capture the vent cover when the vent is uncovered, and move the vent cover toward the vent as the stopper moves toward the pour spout, and the lid/base may have a fence surrounding the blade assembly.

### BRIEF DESCRIPTION OF THE FIGURES

FIG. 1 illustrates a perspective view of a portable blender having a motorized drink-through lid/base and a container vessel.

FIG. 2 illustrates a perspective view the blender with the lid/base and the vessel separated.

FIG. 3 illustrates a top plan view of the motorized drink-through lid/base having a hinged stopper and a vent cover in a closed position.

FIG. 4 illustrates a partial elevation view of the lid/base with the hinged stopper closed and the vent cover closed.

FIG. 5 illustrates a partial elevation view of the lid/base with the hinged stopper partially open and the vent cover closed.

FIG. 6 illustrates a partial elevation view of the lid/base with the hinged stopper partially open and the vent cover slightly raised.

FIG. 7 illustrates a partial elevation view of the lid/base with the hinged stopper fully open and the vent cover raised.

FIG. 8 illustrates a front perspective view of the lid/base with the hinged stopper fully open and the vent cover raised.

FIG. 9 illustrates a rear perspective view of the lid/base with the hinged stopper fully open and the vent cover raised.

FIG. 10 illustrates a perspective view of the lid/base showing sealing features of the blender.

FIG. 11 illustrates a front elevation view of the blender showing the lid/base in a closed position.

FIG. 12 illustrates a rear elevation view of the blender showing the lid/base in a closed position and illustrating the control and charging features on the lid base.

FIG. 13 illustrates a rear elevation view of the blender showing the lid/base in an open position.

FIG. 14 illustrates an exploded view of a first end of the drink through lid including the flip lid and vent cover.

FIG. 15 illustrates an exploded view of a second end of the drink through lid including the blade and sealing mechanisms thereto.

FIG. 16 illustrates a first alternative vessel for the blender.

FIG. 17 illustrates a second alternative vessel for the blender.

FIG. 18 illustrates an alternative embodiment drink-through lid having a blade guard.

FIG. 19 illustrates a cap affixed to the drink-through lid and covering the blade guard and blade.

### DESCRIPTION

The present invention is described more fully hereinafter, but not all embodiments are shown. While the invention has been described with reference to exemplary embodiments, it will be understood by those skilled in the art that various changes may be made, and equivalents may be substituted for elements thereof without departing from the scope of the disclosure. In addition, many modifications may be made to adapt a particular structure or material to the teachings of the disclosure without departing from the essential scope thereof.

The drawings accompanying the application are for illustrative purposes only. They are not intended to limit the embodiments of the present application. Additionally, the drawings are not drawn to scale. Common elements between different figures may retain the same numerical designation.

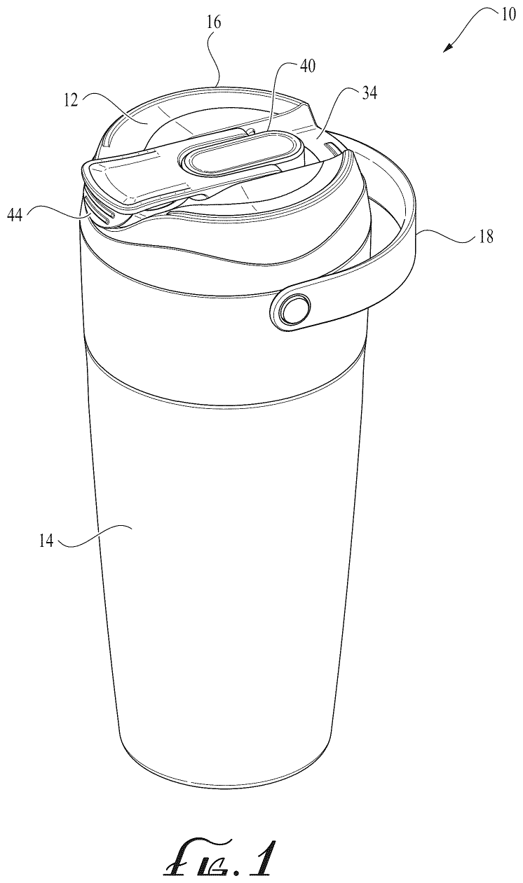

Referring to FIG. 1 a portable blender 10 is shown. The blender 10 comprises a motorized drink-through lid/base 12 and a vessel 14. The lid/base 12 functions as a drink-through lid when the vessel 14 is upright, allowing a user to drink from the blender 10. Alternatively, the lid/base 12 functions as a motor base when the vessel 14 is inverted for a blending operation. In such a configuration, the inverted vessel 14 functions essentially like a “bullet” type blender container.

The blending features of the blender 10, discussed below, are generally self-contained in the lid/base 12. The lid/base 12 preferably has a generally flat profile opposite the vessel 14, thereby allowing the blender 10 to stand unattended on a surface during a blending operation. In the illustrated embodiment, the lid/base 12 includes a base ring 16 configured to contact a flat surface (not shown) and level the blender 10. Additionally, the base ring 16 may be rubberized to create a non-slip connection with the surface. A hinged carry handle 18 is preferably provided on the lid/base 12, enabling the blender 10 to be easily carried.

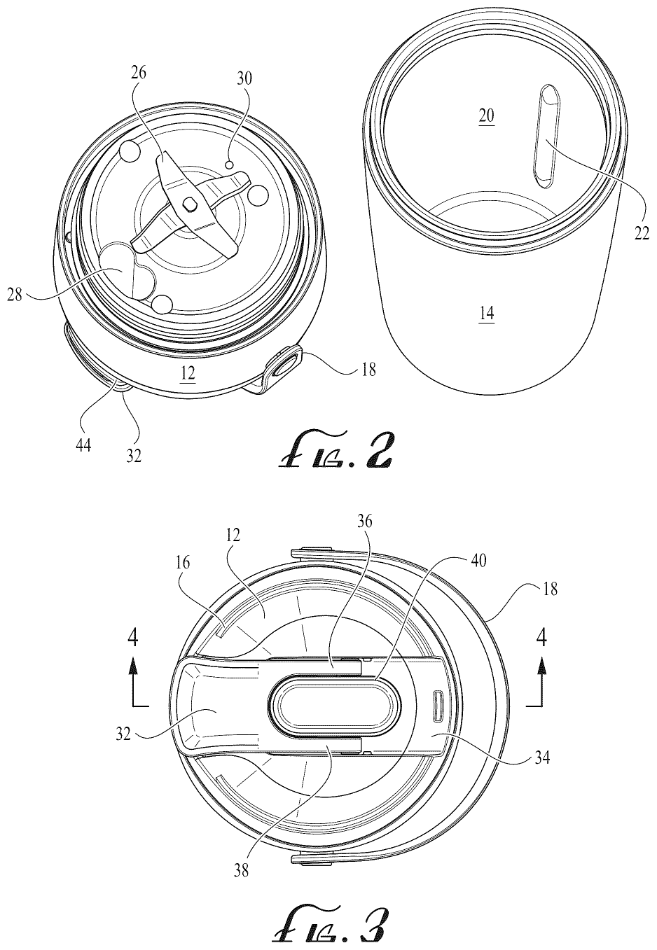

Referring to FIG. 2, the lid/base 12 is shown separated from the vessel 14 to reveal certain internal components of the blender 10. The vessel 14 comprises an internal chamber 20 for containing a material to be blended. One or more ribs 22 may be placed in the internal chamber 20 to help introduce turbulence into materials in the vessel 14 during blending. Additionally, a graduated indicum (not shown) may be embossed or otherwise placed on the internal chamber 16 of the vessel 14 for measuring its contents.

In the illustrated embodiment, the vessel 14 includes a threaded rim 24 for engaging the lid/base 12. Still referring to FIG. 2, the lid/base 12 includes a blade assembly 26 for blending material in the vessel 14. The lid/base 12 has a drink-through pour spout 28 through which a blended liquid (not shown) may be decanted from the blender 10, and a vent 30, which allows air pressure in the vessel 14 to equalize as a blended liquid is decanted from the blender 10 to ensure a smooth pour from the blender 10.

Referring to FIGS. 1-3 a hinged stopper 32 is shown in a closed position. The hinged stopper 32 closes off the pour spout 24. The hinged stopper 30 is connected to the lid/base 12 in a manner enabling it to swing away from the pour spout 24 and ultimately to be securely stowed in a slot 34 atop the lid/base 12 opposite the pour spout 24. The slot 34 and hinged stopper 32 are preferably configured such that the hinged stopper 32 is releasably retained in the slot 34 when installed therein.

In the illustrated embodiment, a first arm 36 and a second arm 38 extend partially around a vent cover 40 configured to cover the vent 26 (FIG. 2). As discussed below, the hinged stopper 32 is configured to raise and lower the vent cover 40, in the manner discussed below, such that the vent 30 is automatically unsealed when the hinged stopper 32 is raised away from the pour spout 28, and resealed when the hinged stopper 32 is pressed into a position sealing the pour spout 28.

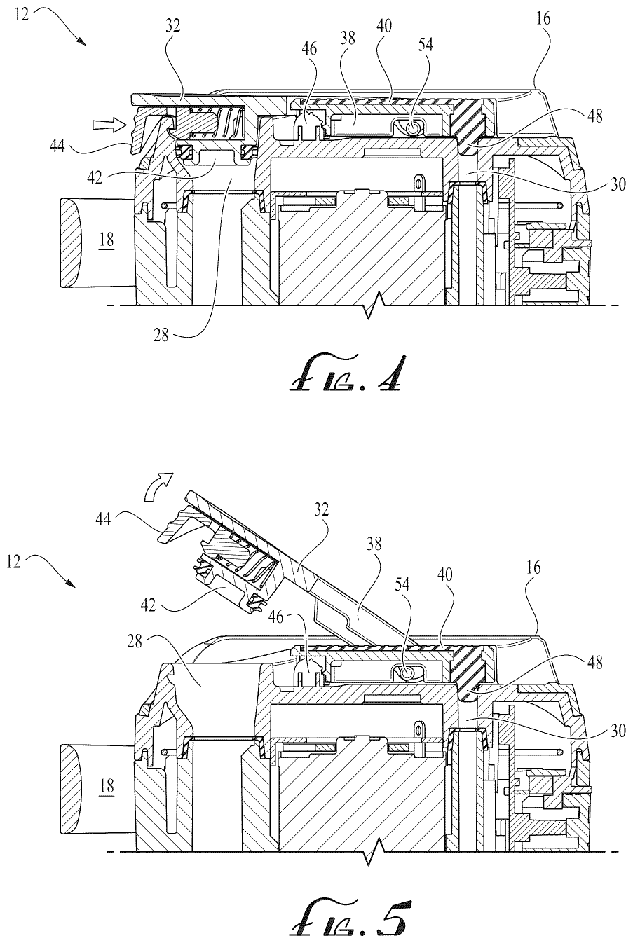

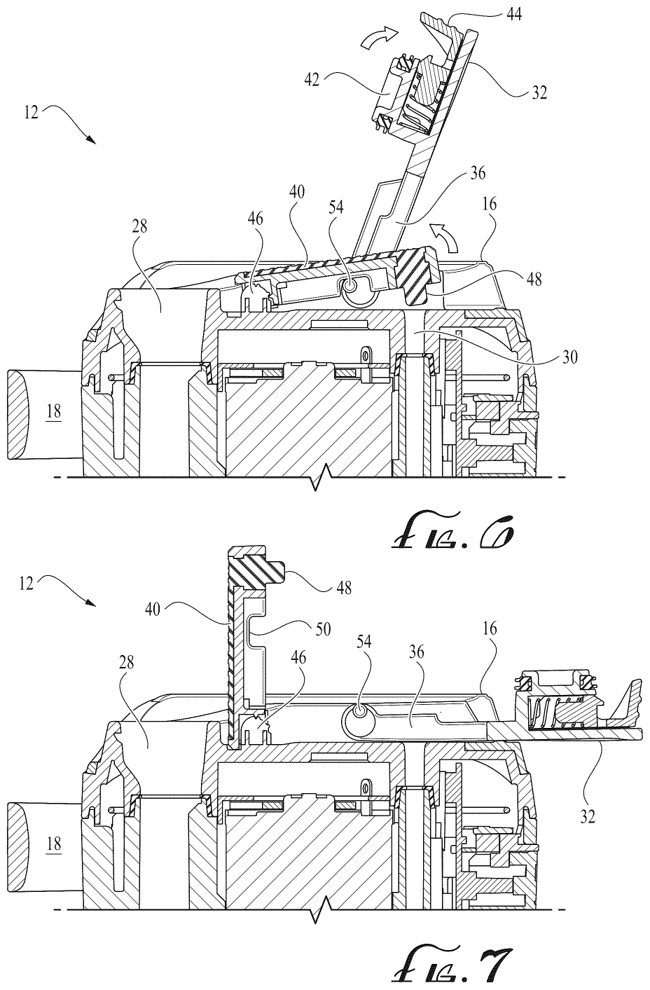

Referring to FIGS. 4-6, the hinged stopper 32 is shown in the process of opening away from the lid/base 12 to prepare the blender 10 for decanting. FIG. 4 shows the lid/base 12 in a closed configuration, with the hinged stopper 32 covering the pour spout 28. FIG. 5 shows the hinged stopper 32 being raised away from the lid/base 12 to expose the pour spout 28, thereby allowing decanting. FIG. 6 shows the hinged stopper 32 as it continues to rotate away from the pour spout 28. As the hinged stopper 32 rotates away from the pour spout 28, it urges the vent cover 40 upward, thereby uncovering the vent hole 26 (FIG. 2) and allowing air to equalize inside the vessel 14 as a liquid (not shown) is decanted from the vessel 14 through the pour spout 28.

Once a preferred quantity of the liquid is decanted through the pour spout 28, the hinged stopper 32 can be lowered back over the pour spout 28 to seal it. In that process, the hinged stopper 32 urges the vent cover 40 back downward until it seals the vent 30. The hinged stopper 32 preferably includes a resiliently sealable plug 42 for sealing the pour spout 28, and may include a releasable thumb switch 44 for facilitating disengaging the hinged stopper 32 from the pour spout 28.

Referring to FIGS. 7-10, the hinged stopper 32 is shown in a fully opened position, and installed into the slot 34 (FIG. 1). In these views, the vent cover 40 is shown having been rotated to a fully upright position away from the lid/base 12 for ease of illustration. It should be understood that in normal operation, the hinged stopper 32 only moves the vent cover 40 slightly away from the lid/base 12 as shown in FIG. 6. In the fully open position, with the hinged stopper 32 captured in the slot 34, the vent cover 40 is prevented from re-engaging the vent 28, as discussed below.

FIG. 7 shows the vent cover 40 raised fully upward and away from the lid/base 12. The vent cover 40 is connected to the lid/base 12 by a hinge 46, allowing the vent cover 38 to rotate toward and away from the lid/base 12. The vent cover 40 includes a vent seal 48 for sealing the vent 30. The vent seal 48 is preferably rubberized in order to provide a watertight seal with the lid/base 12, similar to the plug 42 of the hinged stopper 32. The vent cover 38 includes two opposing side notches 50.

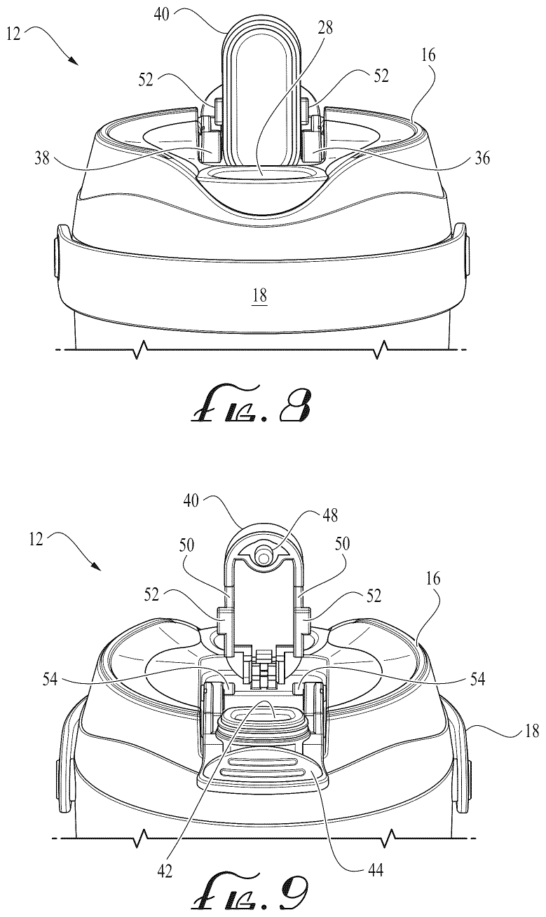

FIG. 8 shows the vent cover 38 raised fully upward and away from the lid/base 12 from a different angle, revealing two opposing side tabs 52 on the vent cover 40. FIG. 9 shows the vent cover 38 raised fully upward and away from the lid/base 12 from the reverse angle of FIG. 8, showing the two opposing side tabs 52 and their proximity to the side notches of the vent cover 40.

As shown in FIG. 9, the hinged stopper 32 includes two side pegs 54, off-set from its connection to the lid/base 12. The side pegs are configured to engage the side notches 50 of the vent cover 40, whereas the first arm 36 and second arm 38 of the hinged stopper 32 are configured to engage the side tabs 52 of the vent cover 40.

Thus, the hinged stopper 32 presses the vent cover 40 against the lid/base 12 (and presses the vent seal 48 into the vent 30) when in a closed position. Alternatively, the side pegs 54 rotate with the hinged stopper 32 to engage the side notches 50 of the vent cover 40, lifting it away from the lid/base 12 (and lifting the vent seal 48 away from the vent 30). When the hinged stopper 32 is rotated back into a closed position, the side pegs 54 rotate away from the side notches 50, and the first arm 36 and the second arm 38 of the hinged stopper 32 engage the side tabs 52 of the vent cover 40, pressing it (and the vent seal 48) back into place against the lid/base 12, sealing the blender 10.

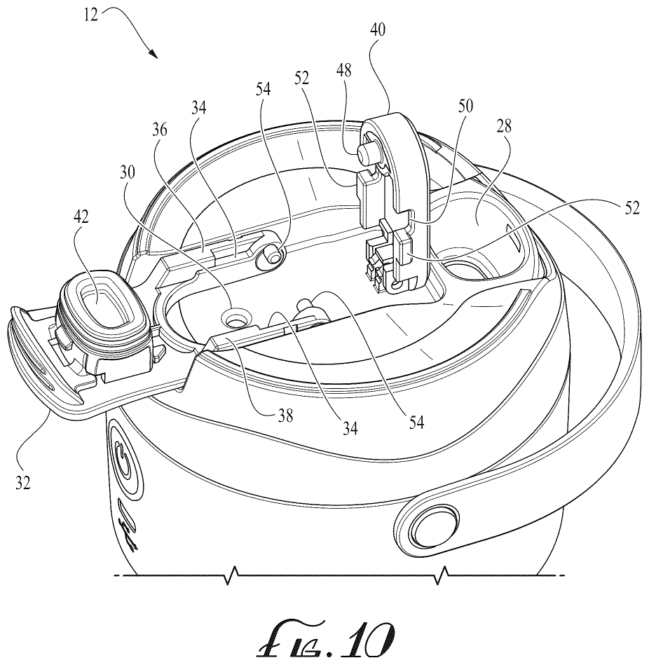

FIG. 10 shows a perspective view of the lid/base 12, with the hinged stopper 32 fully opened and retained in the slot 34, and the vent cover 40 completely raised, as shown in FIGS. 7-9. In this view the vent 30 is shown, to be engaged by the vent seal 48. Also shown in this view are a set of recessed areas 56 on the first arm 36 and the second arm 38. The side pegs 54 align with the side notches 50 on the vent cover 40, whereas the recessed areas 56 each align with the side tabs 52 enabling movement of the hinged stopper 32 to govern movement of the vent cover 40.

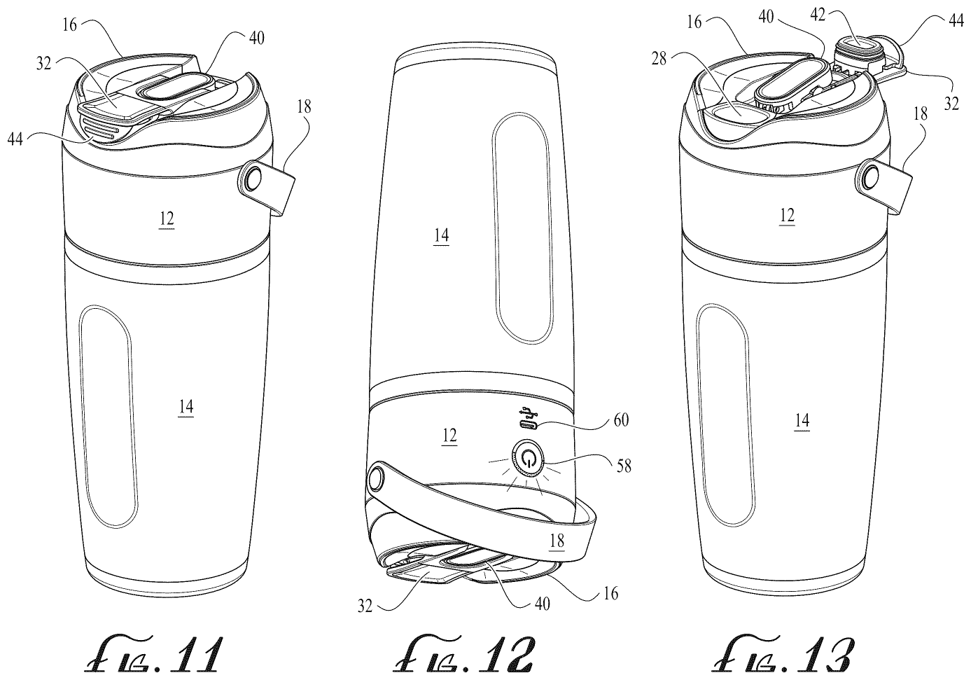

FIGS. 11-13 shown views of the blender 10 in a closed and open configuration. FIG. 11 shows the blender 10 sealed with the hinged stopper 32 and vent cover 40 held in place against the lid/base 12. In this position, the blender 10 functions as a receptacle for blended contents and is ready for being opened and decanting blended contents. FIG. 12 shows the blender in its blending orientation, with the vessel 14 inverted, such that the lid/base 12 is below the vessel 14, allowing the blender to blend the vessel 14 contents. The blender 10 in this orientation can be set on a surface using the base ring 16. In this view the button control 58 is shown indicating that the blender is on and blending, as well as the charging port 60 on the lid/base 12.

FIG. 12 shows the blender 10 unsealed with the hinged stopper 32 installed in the slot 14, and the vent cover 40 raised. In this position, air can travel through the vent 30 while blended material is decanted through the pour spout 28, ensuring a smooth pour from the blender 10. When decanting is finished, the hinged stopper 32 can be rotated back into position with the plug 42 in the pour spout 28, thereby also causing the vent cover 40 to seal the vent 30 as discussed above.

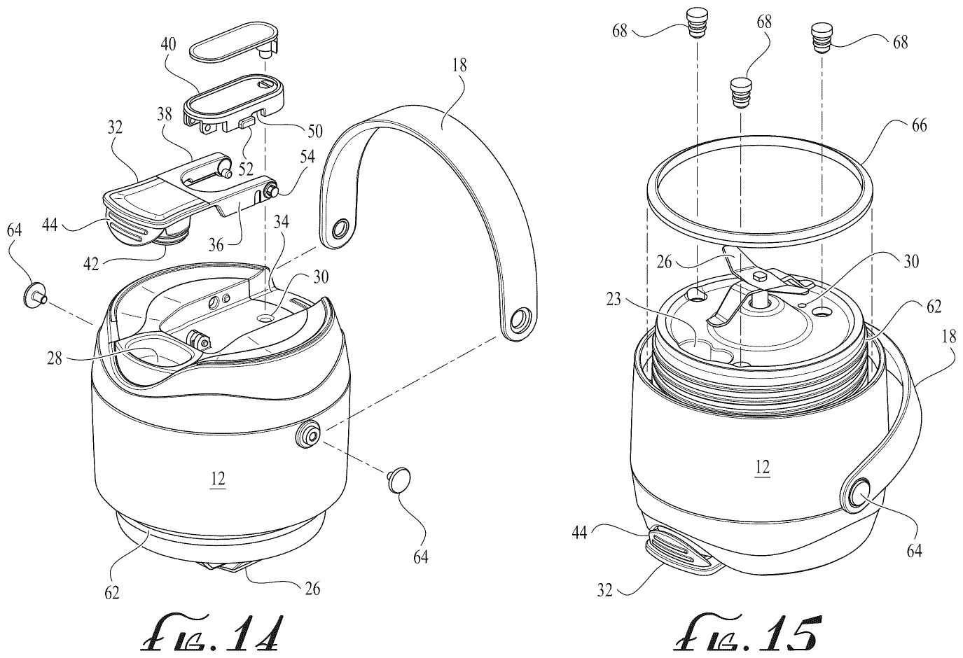

FIGS. 14 and 15 show exploded views of the lid/base 12. In FIG. 14, the hinged stopper 32, vent cover 40, and related sealing components are shown. Additionally, a threaded portion 62 is provided on the lid/base 12 for engaging the threaded rim 24 of the vessel 14. The handle 18 may be affixed to the lid/base 12 using screws 64. FIG. 15 shows the portions of the lid/base 12 which face into the vessel 14. In order to make the blender 10 watertight, a sealing ring 66 may be provided for engaging the threaded rim 24 of the vessel 14 when it is twisted fully onto the threaded portion 62 of the lid/base 12. To prevent liquid in the blender 10 from entering the lid/base 12 internal components (not shown), a series of rubberized sealing plugs 68 may be provided to seal fastener areas of the lid/base 12.

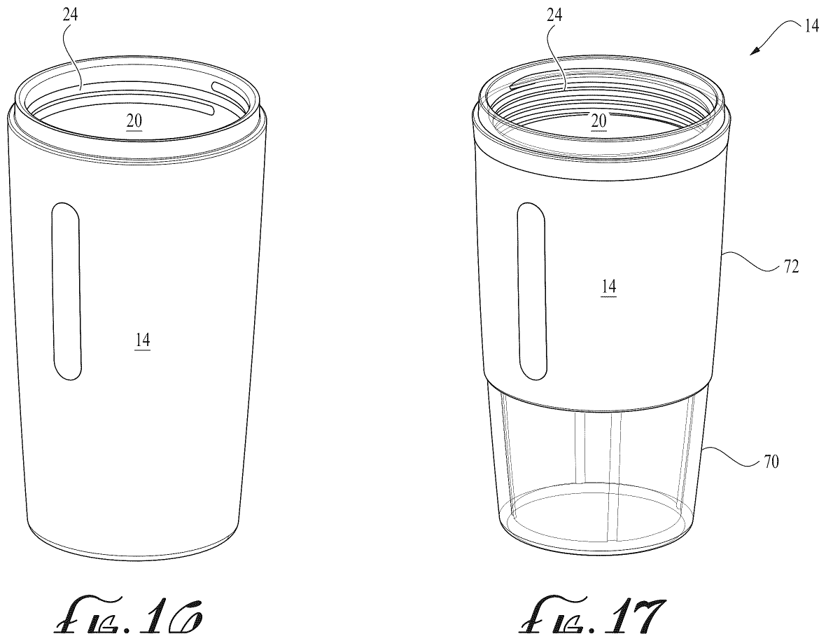

FIGS. 16 and 17 show alternative vessels 14 for the blender 10. FIG. 16 illustrates a vessel 14 made entirely of a single material, such as brushed aluminum, or another suitable resilient material. FIG. 17 illustrates a vessel 14 made of two different materials. A transparent material 70 allows users to see the contents of the blender 10 before, during, and after blending. An insulating material 72, is provided across at least a portion of the vessel 14, which serves the purposes of insulating the vessel contents, and providing a tactile surface that facilitates gripping the blender 10, which is advantageous in the event slippery materials are inadvertently spilled on the surface of the blender 10.

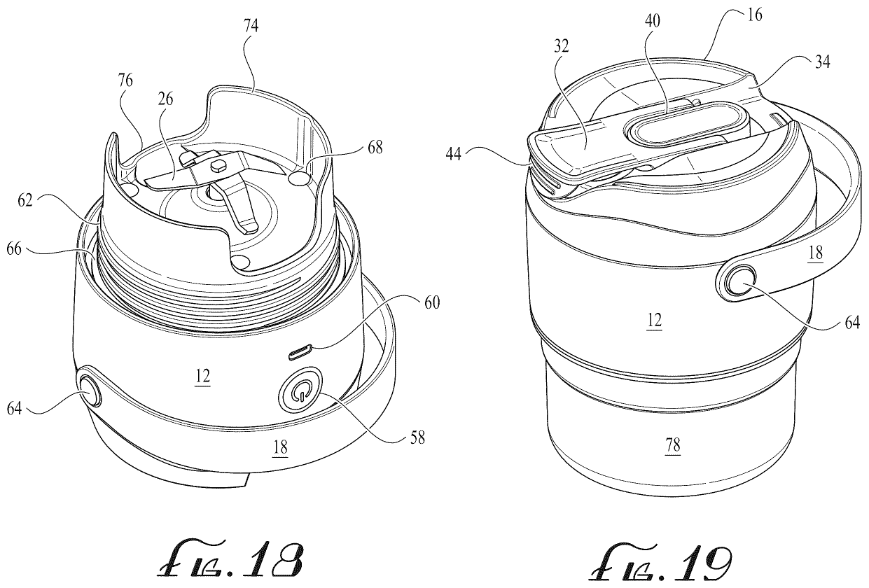

FIG. 18 shows a preferred embodiment with a fence 74 surrounding the blade assembly 26. The fence 74 serves several purposes. Among them are to provide a protecting structure surrounding the blade assembly 26. Although the blender 10 cannot activate with the lid/base 12 and vessel 14 separated, the sharpness of the blade assembly 26 poses some risk of inadvertent contact.

The illustrated blade assembly 26 has only one upturned blade, which does not extend past the fence 74. Another function of the fence 74 is to provide a stand allowing the lid/base 12 to stand on a surface with the blade assembly 26 pointed downward. Another function of the fence is to disrupt the inner surface of the vessel 14, helping to facilitate blending the contents of the blender. In the illustrated embodiment, the fence 74 includes a pair of notches 76, which disrupt the profile of the fence 74.

FIG. 19 shows the lid/base 12 with a cap 78 installed over the blade assembly 26 and blade fence 74. The cap 78 may be included with the blender 10 and can be used for added protection to avoid contacting or damaging the blade assembly 26 when the lid/base 12 is separated from the blender 10 and not in use. Preferably the cap 78 has a flat profile, which allows the lid/base 12 to be set on a surface with the blade assembly 26 pointing downward with the cap 78 installed over the fence 74.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A portable blender comprising:
a container comprising a chamber and an opening to the chamber;
a lid/base configured to be coupled to the container and thereby seal the chamber;
the lid/base comprising a power source, a motor, a control, and a blade assembly, wherein the blade assembly is oriented toward the chamber;
the lid/base further comprising a pour spout and a vent which are open to the sealed chamber;
a closure mechanism comprising a stopper configured to cover the pour spout and a vent cover configured to cover the vent;
the closure mechanism configured such that movement of the stopper governs movement of the vent cover;
wherein moving the stopper away from the pour spout causes the vent cover to move away from the vent; and
wherein moving the stopper to cover the pour spout moves the vent cover to cover the vent.

2. The blender of claim 1 wherein the stopper is connected to the lid/base by a hinge.

3. The blender of claim 1 wherein the vent cover is connected to the lid/base by a hinge.

4. The blender of claim 1 wherein the stopper comprises two arms, and wherein the vent cover disposed between the two arms.

5. The blender of claim 1 wherein the vent cover comprises at least one side tab configured to be engaged by the stopper.

6. The blender of claim 5 wherein the stopper urges the at least one side tab toward the lid/base when the stopper moves toward the pour spout.

7. The blender of claim 1 wherein the vent cover comprises at least one side notch configured to be engaged by the stopper.

8. The blender of claim 7 wherein the stopper comprises at least one off-set peg configured to engage the side notch, and urge the vent cover away from the vent when the stopper is moved away from the pour spout.

9. The blender of claim 1 wherein the stopper is configured to re-capture the vent cover when the vent is uncovered, and move the vent cover toward the vent as the stopper moves toward the pour spout.

10. The blender of claim 1 further comprising a slot for receiving and retaining the stopper when the stopper is moved away from the pour spout.

11. The blender of claim 1 wherein the lid/base comprises a flat profile opposite the container, thereby allowing the lid/base to rest on a surface with the container above the lid/base.

12. The blender of claim 1 wherein the chamber comprises at least one rib configured to introduce turbulence during blending.

13. The blender of claim 1 further comprising a fence surrounding the blade assembly, wherein the fence extends farther away from the lid/base than the blade assembly.

14. The blender of claim 13 wherein the fence comprises at least one notch.

15. The blender of claim 1 wherein the blade assembly comprises a single upturned blade.

16. A portable blender comprising:
a container comprising a chamber and an opening to the chamber;
a lid/base configured to be coupled to the container and thereby seal the chamber;
the lid/base comprising a power source, a motor, a control, and a blade assembly, wherein the blade assembly is oriented toward the chamber;
the lid/base further comprising a pour spout and a vent which are open to the sealed chamber;
a closure mechanism comprising a stopper configured to cover the pour spout and a vent cover configured to cover the vent;
the closure mechanism configured such that movement of the stopper governs movement of the vent cover;
wherein a first movement of the stopper away from the pour spout causes the vent cover to move away from the vent;
wherein a second movement of the stopper to cover the pour spout moves the vent cover to cover the vent; and
wherein a third movement of the stopper away from the pour spout disengages the stopper from the vent cover.

17. The blender of claim 16 wherein the vent cover comprises at least one side tab configured to be engaged by the stopper, wherein urging the at least one side tab toward the lid/base when the stopper moves toward the pour spout.

18. The blender of claim 16 wherein the vent cover comprises at least one side notch configured to be engaged by the stopper and the stopper comprises at least one off-set peg configured to engage the side notch, wherein the off-set peg urges the vent cover away from the vent when the stopper is moved away from the pour spout.

19. Wherein the stopper is configured to re-capture the vent cover when the vent is uncovered, and move the vent cover toward the vent as the stopper moves toward the pour spout.

20. The blender of claim 16 further comprising a fence surrounding the blade assembly, wherein the fence extends farther away from the lid/base than the blade assembly.
